(19) United States
(12) Patent Application Publication
(10) Pub. No.: US 2026/0267880 A1
(43) Pub. Date: Sep. 10, 2026

(54) User Interface

(71) Applicant: Sage Intacct, Inc., San Jose, CA (US)

(72) Inventors: Jeffrey Stern, Herzliya (IL); Pavel Shermayster, Rishon Le Zion (IL)

(73) Assignee: Sage Intacct, Inc., San Jose, CA (US)

(21) Appl. No.: 19/074,852

(22) Filed: Mar. 10, 2025

(51) Int. Cl. G06F 16/332; G06F 3/0482; G06Q 40/12

(52) U.S. Cl. CPC G06F 16/3323; G06F 3/0482; G06Q 40/12

(57) ABSTRACT

A computer implemented method of filtering data records and performing an operation on the filtered data records. Each data record is allocated to a combination of categories, and each category has a category attribute such that each data record is allocated to a particular combination of category attributes. Only certain combinations of category attributes are valid, reflecting a limited set of category attribute combinations to which a data record can be validly allocated. A graphical user interface provides selection controls corresponding to each category and via which the category attributes can be selected. Selection data inputs are received, indicative of a category attribute of a category. Non-valid category attributes are identified and excluded. An operation is performed on the subset of data records stored in the data record system that are assigned a combination of category attributes that include the category attributes indicated by the received selection data inputs.

### TECHNICAL FIELD

The present invention relates to user interfaces for filtering a plurality of data records stored in a data record system and subsequently performing an operation on the filtered data records.

### BACKGROUND

In accounting, a “chart of accounts” is a method of organising financial data. It typically includes both balance sheet accounts (such as assets and liabilities) and income statement accounts (such as revenue and expenses). The chart of accounts forms the basis for categorising and tracking budget allocations within businesses and other organisations.

A chart of accounts usually comprises several “accounts”. Each account relates to a particular category of income or expenditure such as travel expenses or staff development costs.

Each account is typically assigned a numerical code for identification. For example, the code “4200” might represent travel expenses, while “4201” might represent staff professional development.

Budgeting and forecasting tasks often involve allocating budget amounts to given accounts. This is typically over a given period such as month, quarter or year. For example, an organisation may allocate $10,000 for a given month or sequence to travel expenses, and $2000 for a quarter or sequence of quarters to staff professional development.

In more complex settings, for example larger organisations, it is often useful to divide accounts into further, more specific, categories, for example dividing accounts by department, location, or project. In this way, budget amounts can be allocated to, for example, travel expenses associated with a particular location, or staff professional development costs associated with a particular project. More usefully still, categories can be combined, for example enabling budget amounts to be allocated to travel expenses associated with a particular location and a particular project.

In budgeting and forecasting settings, such further sub-categories are commonly referred to as “dimensions”. To give each dimension category a meaningful value, each dimension category is typically associated with a set of possible attributes which are typically determined by the organisation for whom the budgeting is being undertaken.

For example, for a given organisation, the “Project” dimension may include attributes such as “Project Alpha” or “Project Beta” representing different projects undertaken by the organisation; the “Department” dimension may include attributes such as “Product”, “R&D” or “Sales” representing departments within the organisation, and the “Location” dimension may include attributes such as “New York” or “Tel Aviv” representing different physical locations of the organisation.

Like individual accounts, for ease of reference, each dimension attribute is usually given a numerical code. For example, for the “Project” category, “Project Alpha” may be represented as “101” and “Project Beta” as “102”. In the “Location” category “New York” might be represented as “201” and “Tel Aviv” as “202”. Likewise, in the “Department” category, “Product” may be represented as “101”, “R&D” as “102” and “Sales” as “103”.

To assist in organising and visualising data, a given combination of accounts and dimensions is often represented as a “plan line”. In this way, budget amounts (for example, for a given time period such as a month, quarter or financial year) can be “allocated” to specific plan lines or groups of plan lines.

FIG. 1 shows a diagram depicting a number of plan lines for the example described above.

Each account (“Travel Expenses” “4200” and “Staff Professional Development” “4201”) is associated with several dimension categories (“Department”, “Location” and “Project”).

Each combination of account and dimension attributes forms a separate plan line. For example, a first plan line 101 is associated with travel expenses associated with product development for the New York location relating to project Alpha.

If $1000 if budget is to be allocated to travel expenses for sales activities from the New York office relating to project Alpha, then in a budgeting workflow, a budget amount of $1000 can be “allocated” to this plan line.

Because each account and each dimension attribute has its own numerical code, a composite code can be used to identify a specific subset of budget allocations. For instance, the first plan line 101 relating to travel expenses for sales activities from the New York office relating to project Alpha can be referenced using the composite code “4200.101.201.303”.

Composite codes can also be used to refer to larger groups of related budget allocations. For example, all budget allocations associated with Staff Professional Development (account “4201”) for Project Alpha (“101”) in Tel Aviv (“202”) might be referenced using the composite code “4201.101.202”, as shown by a group of plan lines in FIG. 1.

Many known budgeting and financial forecasting software tools use the notion of plan lines to let users allocate, adjust and analyse budget amounts. This is typically part of workflows relating to financial planning, forecasting and spending analysis. Such software tools often display plan lines as rows or entries in an interface, such as a grid or table, where each row represents a specific combination of an account and one or more dimension attributes. Composite codes then serve as a key mechanism to enable these plan lines to be rapidly navigated and the underlying budget allocation data that they represent viewed, analysed and modified.

However, a problem exists with this approach. In the simplified example shown in FIG. 1, all possible plan lines (that is, all combinations of accounts and dimension attributes) are depicted. In practice, not all combinations are meaningful or applicable.

For example, in many organisations certain locations may only support specific departments, or some projects may not involve particular accounts. For instance, referring to FIG. 1, the New York location may only involve the Sales department. This means that plan lines involving the Product or R&D departments in New York would be irrelevant (that is, a budget amount would never be allocated to such a plan line). Similarly, Project Beta may not include Staff Professional Development, making plan lines that include that attribute irrelevant.

This is depicted in FIG. 2.

FIG. 2 presents a diagram similar to FIG. 1 but modified in accordance with certain constraints, namely that the only department in the “New York” location is “Sales”, and Project Beta does not include Staff Professional Development. As can be seen, combinations of dimension attributes that do not correspond to a meaningful plan line are omitted.

Accurate use of composite codes is important for efficient use of these plan line-based systems because users rely on them to rapidly filter, modify and analyse budget allocations across multiple organisational dimensions. However, without guidance, users have no immediate way to know whether a composite code they've constructed represents a valid combination of accounts and dimensions. Although labour intensive, many users simply rely on spreadsheets or other manual methods to track which combinations are actually valid. This is prone to errors and doesn't automatically accommodate changes in valid dimension combinations—for example, if a project is transferred to a different department, or if certain cost categories are restricted to particular locations following a reorganisation. In such cases, previously valid plan lines may become invalid, or new valid combinations may emerge, making manual tracking methods increasingly unreliable.

Keeping track of which composite codes represent valid plan lines is complicated even for the simple example depicted in FIG. 2 which comprises just two accounts and three potential dimensions. For larger or more complex organisations, where there may be dozens of dimensions and multiple attributes for each, combined with tens or even hundreds of accounts the sheer number of possible codes, this issue is exacerbated further.

Despite these factors, many system simply check whether a composite code has the correct format, without verifying whether it is represents a valid combination, allow invalid plan lines to persist.

### SUMMARY OF THE INVENTION

In accordance with a first aspect of the invention, there is provided a computer implemented method of filtering a plurality of data records stored in a data record system and subsequently performing an operation on the filtered data records, wherein said data records are stored in the data record system such that each data record is allocated to a combination of categories from a set of categories, and each category of the combination of categories has a category attribute selected from a set of category attributes associated with that category such that each data record is allocated to a particular combination of category attributes and wherein only certain combinations of category attributes are valid reflecting a limited set of category attribute combinations to which a data record can be validly allocated, said method comprising:
a. providing, via a graphical user interface on a computing device, a plurality of selection controls corresponding to each category and via which the category attributes for each category can be selected;
b. sequentially receiving one or more selection data inputs from a user via the selection controls, each selection data input indicative of a category attribute of a category, and
c. every time a selection data input is received, identify category attributes which if subsequently selected would form a non-valid set of category attributes given the category attributes selected in accordance with the previously received selection data inputs, and exclude the identified category attributes from selection via the selection controls,
d. receiving confirmation data input indicating a full set of selection data inputs has been provided and receiving operation instruction data indicative of an operation, and
e. performing the operation on the subset of data records stored in the data record system that are assigned a combination of category attributes that include the category attributes indicated by the received selection data inputs.

Optionally, the data records are budget allocation data records.

Optionally, the set of categories comprises an account code category corresponding to account codes, and the remaining categories comprise account dimensions categories, each account dimension category representing a class of attributes associated with budget allocations.

Optionally, the set of category attributes associated with the account code category comprise a set of account codes.

Optionally, the set of category attributes associated with each account dimension category comprise a set of budget allocation attributes associated with that account dimension category.

Optionally, step c) of the method comprises identifying the category attributes by referencing a data set indicative of valid category attribute sets.

Optionally, step c) of the method comprises excluding selection of one or more attributes by one of: (i) greying out or disabling said attributes within a selection control; (ii) removing or hiding said attributes from the selection control; (iii) displaying a warning or error message when a user attempts to select said attributes; or (iv) highlighting said attributes as invalid using a distinguishing colour or icon.

Optionally, the plurality of selection controls comprise a plurality of drop-down menus.

Optionally, the plurality of drop-down menus comprise a drop-down menu for each category, and wherein a graphical element corresponding to each category attribute is presented via the respective drop-down menu, and selection data input is received indicative of selection of a category attribute on selection of a graphical element corresponding to that graphical element.

Optionally, the operation is one of a predetermined set of operations, and comprises a display operation in which the subset of data records are displayed on the graphical user interface.

Optionally, the operation is one of a predetermined set of operations, and comprises a data processing operation in which a data processing operation is applied to the subset of data records.

Optionally, the graphical user interface is provided within a computer implemented tool for undertaking accounting budgeting tasks.

In accordance with a second aspect of the invention, there is provided a computer system for enabling a user to filter a plurality of data records stored in a data record system and subsequently performing an operation on the filtered data records, wherein
said data records are stored in the data record system such that each data record is allocated to a combination of categories from a set of categories, and each category of the combination of categories has a category attribute selected from a set of category attributes associated with that category such that each data record is allocated to a particular combination of category attributes and wherein
only certain combinations of category attributes are valid reflecting a limited set of category attribute combinations to which a data record can be validly allocated, said system comprising:
a display function configured to control a computing device to display on a display connected to the computing device a graphical user interface comprising a plurality of selection controls corresponding to each category and via which the category attributes for each category can be selected;
an input data processing function configured to sequentially receive one or more selection data inputs via the selection controls from a user controlling input means connected to the computing device, each selection data input indicative of a category attribute of a category;
a filter function which each time a selection data input is received, is configured to identify category attributes which if subsequently selected would form a non-valid set of category attributes given the category attributes selected in accordance with the previously received selection data inputs, and control the display function to exclude the identified category attributes from selection via the selection controls, and
an operation implementing module which upon the input data processing receiving function receiving confirmation data input indicating a full set of selection data inputs has been provided and receiving operation instruction data indicative of an operation, is configured to perform the operation on the subset of data records stored in the data record system that are assigned a combination of category attributes that include the category attributes indicated by the received selection data inputs.

Optionally, the data records are budget allocation data records.

Optionally, the set of categories comprises an account code category corresponding to account codes, and the remaining categories comprise account dimensions categories, each account dimension category representing a class of attributes associated with budget allocations.

Optionally, the set of category attributes associated with the account code category comprise a set of account codes.

Optionally, the set of category attributes associated with each account dimension category comprise a set of budget allocation attributes associated with that account dimension category.

Optionally, the filter function is configured to identify the category attributes by referencing a data set indicative of valid category attribute sets.

Optionally, the display function is configured to exclude selection of one or more attributes by control the computing device to display on the display connected the graphical user interface such that one of: (i) said attributes are greyed out or disabled within a selection control; (ii) said attributes are removed or hidden from the selection control; (iii) a warning or error message is displayed when a user attempts to select said attributes; or (iv) said attributes are highlighted as invalid using a distinguishing colour or icon.

Optionally, the plurality of selection controls comprise a plurality of drop-down menus.

Optionally, the plurality of drop-down menus comprise a drop-down menu for each category, and wherein a graphical element corresponding to each category attribute is presented via the respective drop-down menu, and selection data input is received indicative of selection of a category attribute on selection of a graphical element corresponding to that graphical element.

Optionally, the operation is one of a predetermined set of operations, and comprises a display operation in which the subset of data records are displayed on the graphical user interface.

Optionally, the operation is one of a predetermined set of operations, and comprises a data processing operation in which a data processing operation is applied to the subset of data records.

Optionally, the graphical user interface is provided within a computer implemented tool for undertaking accounting budgeting tasks.

In accordance with a third aspect of the invention, there is provided a computer program which when implemented on a computer system controls the computer system to perform a method according to the first aspect.

In accordance with examples of the invention a technique is provided for filtering data records that addresses the problem of invalid or irrelevant data groupings—such as those caused by combining accounts and dimension category attributes that are not meaningful or applicable for an organisation's accounting needs.

Specifically, a graphical user interface is provided in which, as a user sequentially inputs selection data via selection controls, selection of category attributes which if subsequently selected would form a non-valid set of category attributes given the selected category attribute and any category attributes previously selected are excluded from selection via the selection controls. This ensures that a user can only provide selection data relating to valid combinations of category attributes, e.g. valid combinations of account codes and dimensions category attribute codes that relate to valid plan lines or groups of valid plan lines within a chart of accounts. Consequently, users are prevented from inadvertently creating or referencing invalid plan lines, reducing errors and easing the burden of maintaining accurate, up-to-date references within an accounting system.

In addition, techniques in accordance with embodiments of the invention offer further benefits. By automatically filtering out incompatible or irrelevant category attributes, the system reduces the need for manual checks, thereby increasing efficiency. The dynamic filtering process ensures that the interface always presents the most up-to-date, valid options, even in complex environments with many accounts and dimensions. This not only improves data integrity but also streamlines workflows such as budgeting work flows. Moreover, by clearly presenting only valid selections, the interface enhances the user experience and reduces the training required to use the system effectively.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a diagram depicting of combinations of dimension category attributes to which an accounting transaction data record could potentially be allocated in accordance with an illustrative example;

FIG. 2 provides a diagram depicting of combinations of dimension category attributes corresponding to that shown in FIG. 1 but modified on the basis of certain constraints;

FIG. 3 depicts a graphical user interface for display on a computing device in accordance with certain examples of the invention;

FIG. 4 provides a simplified schematic diagram depicting software components for implementing a graphical user interface device in accordance with certain examples of the invention;

FIG. 5 provides a diagram depicting a process implemented by the software components depicted in Figure for implementing a graphical user interface device in accordance with certain examples of the invention;

FIGS. 6a to 6d depict a graphical user interface as it is used to receive selection data input from in accordance with certain examples of the invention, and

FIG. 7 provides a simplified schematic diagram depicting an example implementation of the invention.

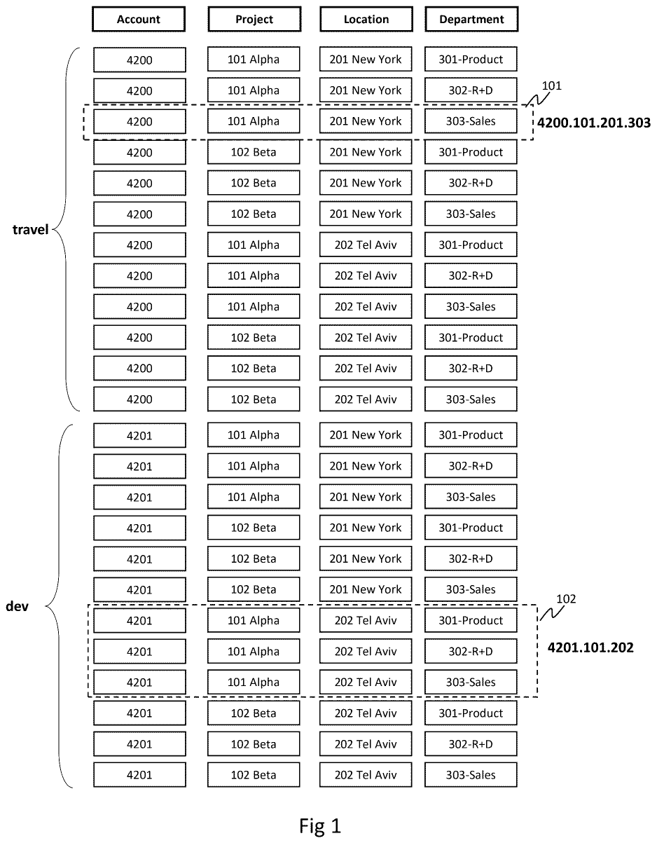

### DETAILED DESCRIPTION

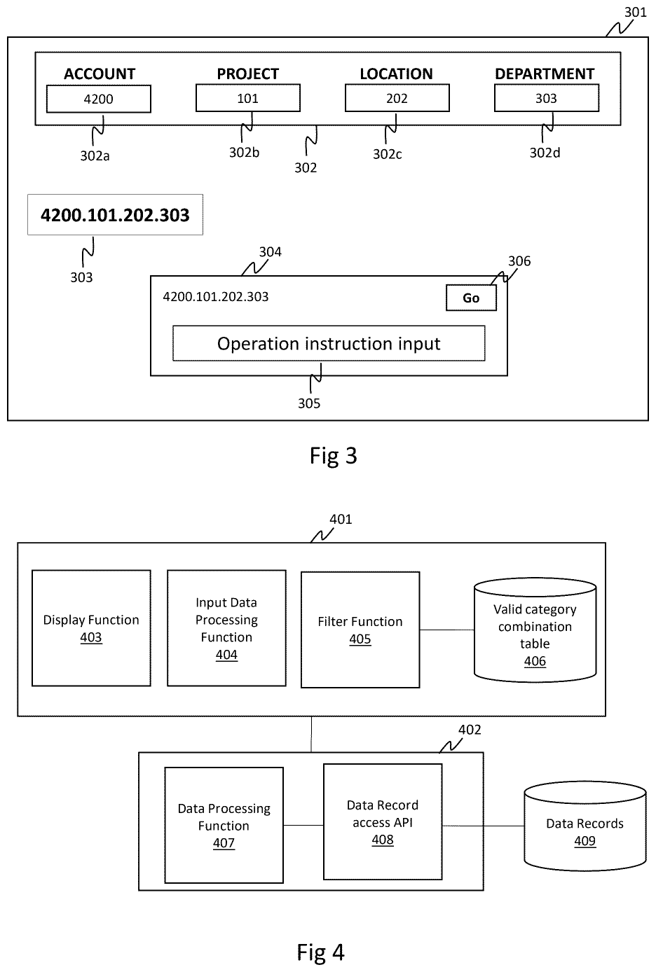

FIG. 3 depicts a graphical user interface 301 for display on a computing device, which implements a method of filtering data records that addresses the problem of invalid or irrelevant data groupings-such as those caused by combining accounts and dimension category attributes that are not meaningful or applicable for an organisation's accounting needs. The graphical user interface 301 is adapted to allow the systematic filtering of data records allocated to different category combinations.

Specifically, operation of the graphical user interface 301 is adapted to allow the systematic filtering of data records (such as budget allocation data records) that are stored in a data record system (such as a financial budgeting system) where each data record is allocated to a combination of categories from a predetermined set of categories (e.g. allocated to a specific account category from a set of account categories, where each account category is associated with a specific set of dimensions categories) and where each category has a category attribute (for example specific accounts and specific dimensions category attributes). However, as explained below, display of the graphical user interface is adapted to take account of the fact that only certain combinations of category attributes are valid, reflecting a limited set of category attribute combinations to which a data record can be validly allocated (e.g. data records can only be meaningfully allocated to certain combinations of accounts and dimensions category attributes).

Examples of the graphical user interface 301 find particular utility in the context of software applications adapted for financial budgeting tasks. Such applications allow users to retrieve, edit, and analyse budget-related data, and in particular budget allocation data which is data indicative of a financial amount (e.g. a money value) allocated to a particular category of spending.

In typical cases, this is achieved via a plan line-based interface that represents valid combinations of account codes and dimension attributes. As described in more detail below, the graphical user interface 301 addresses the problem of invalid or irrelevant plan lines, ensuring that only valid combinations are selectable.

The graphical user interface 301 comprises a first graphical element 302 which comprises a plurality of selection controls corresponding to each category to which a data record can be allocated. In this example, this includes a first selection control 302a for the “account” category; a second selection control 302b for the “Project” dimension category; a third selection control 302c for the “Location” dimension category, and a fourth selection control 302d for the “Department” dimension category. As will be explained in more detail below, in certain embodiments, these selection controls are in the form of drop-down menus which are activated on selection of the selection control. <In typical examples many more accounts and many more dimensions>.

Each of these selection controls is configured to receive selection data input from a user for selecting a category attribute. For example, FIG. 3 depicts an initial state in which the first selection control 302a has been used to select the account category attribute “4200” (e.g. the account associated with “Travel Expenses”); the dimension category attribute “101” (e.g. dimension category “Project” associated with “Alpha”); the dimension category attribute “202” (e.g. dimension category “Location” associated with “Tel Aviv”), and the dimension category attribute “303” (e.g. dimension category “Department” associated with “Sales”).

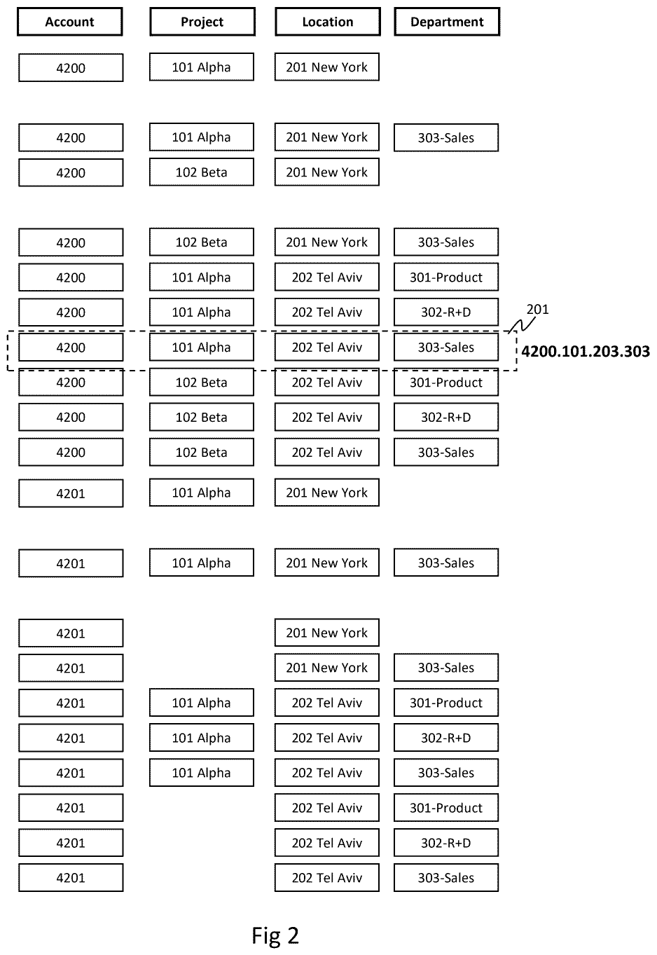

As will be understood, the selection of these category attributes corresponds to a selection of combination of category attributes that specifies a plan line or a group of plan lines. The graphical user interface 301 includes a second graphical element 303 which displays the composite code of the currently selected plan line or group of plan lines. In the example shown in FIG. 2, this is the composite code “4200. 101.202.303” representing the plan line 201.

The graphical user interface 301 comprises a third graphical element 304 via which operation instruction data can be received via an input element 305 specifying an operation, for example a data display operation (e.g. displaying the selected plan lines in a table or chart format) or a data processing operation (e.g. allocating or modifying budget allocation data, computing a sum or generating a statistical summary) on data records allocated to the currently selected plan line or group of plan lines.

Graphical element 304 includes a confirmation input control 306 (for example, a “GO” button) through which the user provides confirmation data input. This input shows that a full set of selection data inputs has been entered, thereby selecting the desired plan line or group of plan lines.

When the confirmation input control 306 is activated, the operation corresponding to the operation instruction data input via input element 305 is carried out. This operation is performed on the subset of data records in the data record system that are assigned to the combination of category attributes, by the received selection data inputs (that is, the selected plan line or group of plan lines).

In use, display of the graphical user interface 301 is controlled so that a user can only provide selection data relating to valid combinations of category attributes, i.e. valid combinations of account codes and dimensions category attribute codes that relate to valid plan lines or groups of valid plan lines. Specifically, as a user sequentially inputs selection data via the selection controls, dimension category attributes which if subsequently selected would form a non-valid set of category attributes given the selected dimension category attribute and any account and dimension category attributes previously selected are identified and then excluded from selection via the selection controls. Typically, category attributes are identified for exclusion by referencing a data set indicative of valid category attribute sets, such as valid category combination table. Dimension category attributes can be excluded from selection in any suitable way which would be familiar to the skilled person, for example by techniques such as greying out or disabling said attributes within the selection control; removing or hiding said attributes from the selection control; displaying a warning or error message when a user attempts to select said attributes; or highlighting said attributes as invalid using a distinguishing colour or icon.

A detailed example of this is explained further to reference with FIGS. 4, 5 and FIGS. 6a to 6d using an example in which combinations of valid dimension category attributes correspond to those shown in FIG. 2.

FIG. 4 provides a simplified schematic diagram depicting software components for implementing the graphical user interface 301 on a computing device and FIG. 5 provides a diagram depicting a process implemented by the software components.

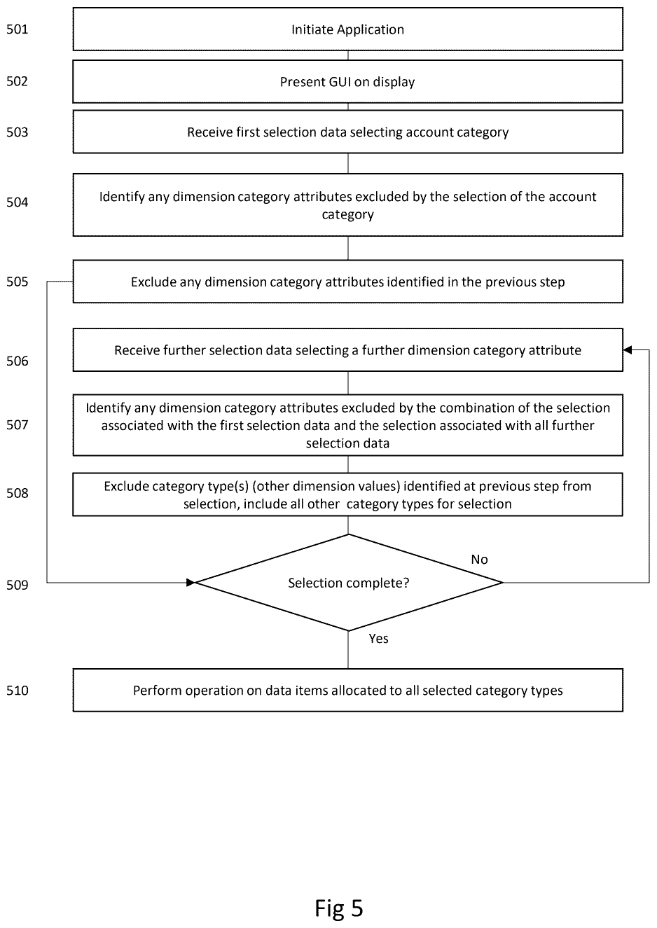

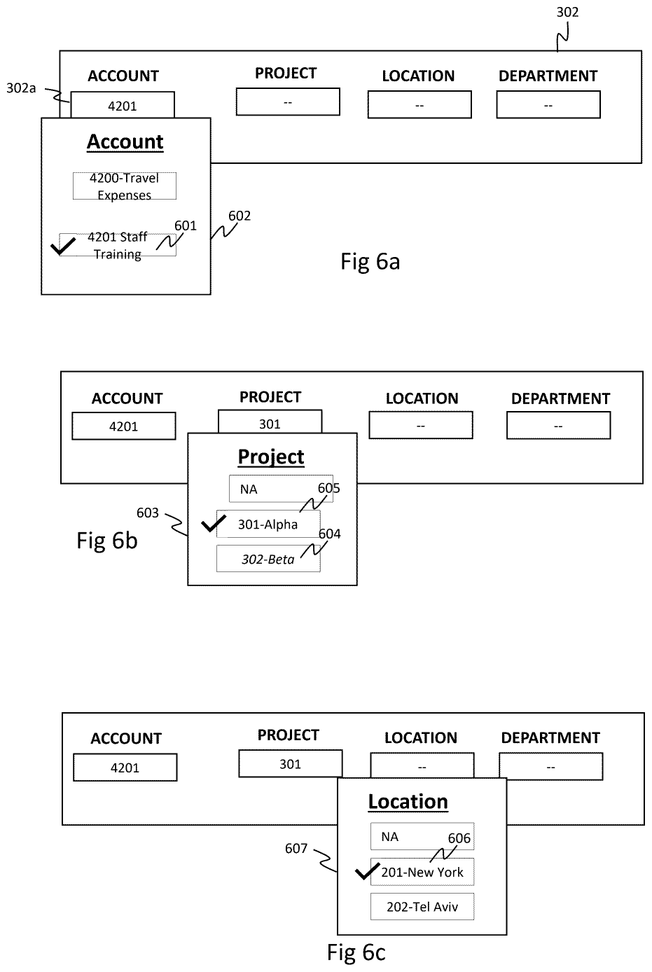

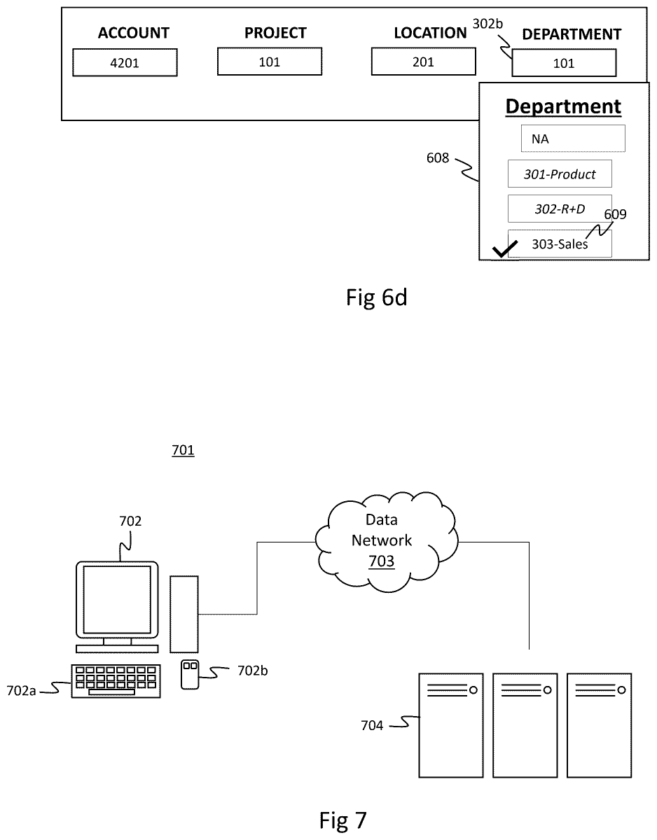

FIGS. 6a to 6d depict the graphical user interface 301 as it is used to receive selection data input from a user.

As can be seen from FIG. 4, the software components comprise a graphical user interface module 401 and an operation implementing module 402.

The graphical user interface module 401 comprises a display function 403, an input data processing function 404, a filter function 405, and a valid category combination table 406, to which the filter function 405 has access. The display function 403 handles tasks related to displaying and rendering the graphical user interface 301 on the computing device. The input data processing function 404 manages tasks associated with receiving and processing data inputs provided by the user via the interface 301. The filter function 405 identifies and excludes control elements from the selection controls that, if selected, would result in an invalid plan line being chosen. The valid category combination table 406 has stored therein data indicative of valid combinations of category attributes (e.g. account categories and dimension category attributes) that constitute valid plan lines.

The operation implementing module 402 comprises an operation implementing function 407 and a data record access API 408 via which data records stored in a data record database 409 can be accessed. The operation implementing function 407 is configured to perform operations on the data records selected by the user via the graphical user interface 301 provided by the graphical user interface module 401.

As the skilled person will appreciate, the operation performed by the operation implementing function 407 can be selected from a predetermined set of operations, depending on the requirements of the system. For instance, in one example, the operation implementing function 407 may perform display operations that causes the subset of data records to be displayed on the graphical user interface 301. In that scenario, the display function 403 of the graphical user interface module 401 handles the rendering tasks, ensuring the selected data records appear in a suitable format (for example, a table or chart) on the user's computing device.

Alternatively or additionally, the operation implementing function 407 may apply a data processing operation to the subset of data records, such as allocating a value to a data record, summing or aggregating values, generating statistical analyses (averages or other metrics), or producing formatted reports for review or archiving. These examples are not exhaustive, and the operation implementing function 407 may be configured to perform any suitable operation on the filtered data records. In settings in which the graphical user interface 301 is implemented as part of a budgeting software tool where the data records are budget allocation data indicative of budget allocation values attributed to different accounts and dimensions associated with those accounts, examples of such operations might include allocating a budget allocation value to a plan line, modifying an existing budget allocation value, aggregating budget allocation values across a group of plan lines, generating forecast data, and producing variance reports for further analysis.

In the following example, a user wishes to modify a budget allocation amount for staff development costs associated with Project Alpha for staff based in Tel Aviv. For example, the user may input a command line instruction such as “increase budget allocation by $500” into the input element 305, thereby instructing the system to add $500 to the current budget allocation value associated with the selected plan line. This command facilitates the common practice of adjusting budget allocations to meet additional spending requirements.

Referring to FIG. 5, at a first step 501 the user initiates an application including the graphical user interface module 401.

At a second step 502, the display function 403 of the graphical user interface module 401 controls the computing device to present the graphical user interface 301 on a display.

In certain examples, assuming, no selections have yet been made, the display function 403 only enables access to the first selection control 302a, requiring the user to select an account category. This is depicted in FIG. 6a.

Although not necessary in all examples, in some examples this restriction is useful because it guides the user to first select an account category. By doing so, the system can immediately filter out any incompatible dimension category attributes. This ensures that subsequent selections are only made from valid options, thereby reducing errors and streamlining the selection process.

At a third step 503, the input data processing function 404 receives first selection data from the first selection control 302a relating to the account category. In this example, this is account “4201”.

As can be seen from FIG. 6a, this selection can be by virtue of a user selecting a first selection element 601 displayed on a first drop-down menu 602 of the first selection control 302a of the first graphical element 302.

At a fourth step 504, the filter function 405 is configured to identify any dimension category attributes excluded by the selection of the account category selected at the third step 503 by referencing a data set indicative of valid category attribute sets. This can be implemented in any suitable way. For example, the filter function may retrieve the entire valid category combination table 406—or only a relevant subset of it based on the current selection—from a local or remote data store. The filter function 405 then executes a comparison process where, for each candidate dimension category attribute, it constructs a potential composite code by combining the selected account category (e.g. “4201”) with the candidate attribute. This potential composite code is then compared against the entries in the valid category combination table 406. If the composite code is not found in the table, the candidate attribute is determined to be invalid and is excluded from further selection to prevent the formation of an invalid plan line In this example, the filter function 405 is configured to refer to the valid category combination table 406 to determine if the selection of the account category “4201” excludes any other dimension category attributes from selection to avoid an invalid plan line.

As will be understood with reference to FIG. 2, in this instance, the selection of the account category “4201” excludes the dimension category attribute “Beta” from subsequent selection because in accordance with the constraints discussed above, Project “Beta” does not involve Staff Professional Development. This is achieved by “greying out” this option. Consequently, in this instance, at a fifth step 505, the filter function 405 controls the display function 403 to exclude the dimension category attribute “Beta” from selection.

An example of this exclusion is depicted in FIG. 6b which depicts the first graphical element 302 after the user subsequently selects the fourth selection control 302d.

As can be seen, a second drop-down menu 603 is presented and a selection element 604 associated with the dimension category attribute “Beta” being excluded from selection (thus only the dimension category attribute “Alpha” or “NA” are selectable). Assuming the user provides further selection data input (indicated by a ninth step 509), the process proceeds to a sixth step 506 where the input data processing function 404 receives further input selection data selecting a further dimension category attribute. In this instance, this is the dimension category attribute “Alpha”.

This selection is by virtue of a user selecting a further selection element 605 displayed on the second drop-down menu 603.

At a seventh step 507, the filter function 405 is configured to identify all dimension category attributes excluded by the combination of the first selection associated with the first selection data (selecting the account category) and further selection data (selecting the dimension category attribute selected at the sixth step 506). Specifically, in this instance, the filter function 405 is configured to refer to the valid category combination table 406 to determine if the selection of the dimension category attribute “Alpha” along with the previously selected account category “42001 excludes the selection of any further dimension category attributes of other dimension categories. As can be seen from FIG. 2, a number of valid plan lines comprise both the account category “4201” and the dimension category “Alpha”, therefore, in this instance no further dimension category attributes are excluded.

Assuming the user provides further selection data input (indicated by a ninth step 509), the process returns to the sixth step 506 where the input data processing function 404 receives further input selection data selecting a further dimension category attribute. In this instance, this is the dimension category attribute “New York”. As can be seen from FIG. 6c, this selection is by virtue of a user selecting a further selection element 606 displayed on a third drop-down menu 607.

The process then returns again to the seventh step 507, where the filter function 405 is configured to identify all dimension category attributes excluded by the combination of the first selection associated with the first selection data and the previously received selections.

As will be understood with reference to FIG. 2, in this instance, the selection of the account category “4201” in combination with the dimension category attributes “Alpha” and “New York” exclude the dimension category attributes “Product” and “R+D” from subsequent selection so in this instance, at the seventh step 507, the filter function 405 identifies these dimension category attributes for exclusion and controls the display function 403 to exclude these dimension category attributes from selection.

Assuming the user provides further selection data input (indicated by a ninth step 509), the process returns to the sixth step 506 where the input data processing function 404 receives further input selection data selecting a further dimension category attribute. In this example, as shown in FIG. 6d, at the sixth step 506, the second selection control 302b is selected and a corresponding drop-down menu 608 is displayed.

Because the dimension category attributes “Product” and “R+D” have been excluded from subsequent selection, the only selection elements selectable on the drop-down menu 603 of the second selection control 302b is the selection element 609 associated with dimension attribute category “Sales” which in this instance is selected by the user, an “NA”.

With a complete valid plan line, no further exclusions are required, therefore the process proceeds to the ninth step 509, where assuming the user provides no further selection data input, the process proceeds to the tenth step 510 where upon activation of the confirmation input control 306, the filter function 405 is configured to forward the selected plan line or plan lines to the operation implementing module 402 where the data record database 407, via the data record access API 408, retrieves the relevant data records (in this example, the data record stored in the data record database 409 and allocated to the 4200.101.202.301 plan line) and performs the operation specified in the input element 305.

In this example, the operation implementing module 402 first retrieves the data record from the data record database 409 corresponding to the selected plan line. The module then computes a new budget allocation value by adding $500 to the current budget allocation value stored in the record. Once the calculation is completed, the module generates output data-for example, an updated display or confirmation message- and subsequently writes the updated budget allocation value back to the data record database 409 via the data record access API 408. This process ensures that the new budget amount is accurately applied and reflected in the stored data.

The approach described above demonstrates a key advantage of the invention. By automatically filtering out invalid combinations of category attributes, the system ensures that only valid plan lines are selected. For instance, without this filtering, a user might inadvertently input a syntactically correct composite code, such as “4201.102.202.303”, which, although the code format is correct, the combination does not represent a valid plan line, leading to potential misallocation of the budget allocation value and erroneous financial reports. As will be understood, by disallowing the selection of incompatible attributes, data integrity is improved and any need for users to manually verify correct composite codes is reduced.

In the example described above, an account category and a dimension category attribute are selected for the account, and each dimension category thereby selecting a specific plan line. However, it will be understood that the interface also allows (by virtue of the selection of the “NA” selection element provided in the drop-down menus) a group of valid plan lines to be selected. For example, if selections were made giving rise to the following composite code 4200.101.202 (EG by selecting the NA selection element from the fourth selection control 302d), this would identify all transaction records associated with travel expenses for project Alpha in Tel Aviv relating to any valid department.

As the skilled person will appreciate, examples of the invention can be implemented in various ways. FIG. 7 provides a simplified schematic diagram depicting an example implementation of the invention.

As shown, the system 701 comprises a user device 702 connected via a data network 703 to a server system 704. The user device 702 may be any suitable computing device, such as a desktop computer, laptop, tablet, or smartphone, equipped with a display and at least one user data input mechanism 702a, 702b (for example, a touchscreen, keyboard, or mouse) for receiving data selection inputs from a user.

The server system 704 may be realised by a single server machine or a distributed set of machines (for instance, in a cloud-based environment), each running software and data management functionality for the ERP system. Although, in one typical example, the data network 703 is provided by the Internet, it will be appreciated that any suitable form of network that facilitates data communication between the user device 702 and the server system 704 may be used, including, for example, an intranet, a local area network (LAN), or a wireless data network.

In this example, an interface in accordance with examples of the invention is displayed on the display of the user device 702. This is achieved by including suitable code within the web data served from the server system 704 to the user device 702. By way of example, such code may comprise HTML, CSS, JavaScript, or a web-app package that can be fetched either upon an initial page load or dynamically using AJAX or REST calls. Software running on the user device 702 interprets this code, such as rendering HTML and executing JavaScript, to instantiate the graphical user interface module 401, thereby enabling user interactions and providing the functionality to filter and select data records. In certain implementations, the user device 702 may also employ local or session-based storage to temporarily hold filtered data prior to sending a request to the server system 704, thereby facilitating partial or incremental updates to the displayed data set.

The filtering and selection of data records are performed on the user device 702 under the control of the user via the interface provided by the graphical user interface module 401. Access to certain filtering operations or data sets may be subject to user authentication or role-based permissions, ensuring that only authorised users can access and filter specific records. Once the user determines a subset of “filtered” data records, corresponding selection data is communicated to the server system 704 along with data identifying the relevant operation to be performed.

The server system 704 has running thereon functionality implementing the operation implementing module 402, along with a data storage system implementing the data record database 407 for storing and managing data records. In one example, the operation implementing module 402 includes instructions for querying the data record database 407 via a suitable database API, which may employ SQL, NoSQL, or other known data management techniques. Responsive to receipt of the selection data, the operation implementing module 402 retrieves the relevant data records from the data record database 407 and performs the specified data processing operation on the retrieved subset of data records.

As the skilled person will understand, the valid category combination table 406, which defines permissible combinations of category attributes, can be stored either locally on the user device 702 that renders the display or remotely on the server system 704. When stored locally, the table allows for quick access and efficient filtering operations directly on the user device 702. Alternatively, when stored remotely, the table can be accessed via data network 703, enabling centralized management and consistency across multiple user devices.

Regardless of the storage location, the valid category combination table 406 can be updated in real-time to reflect changes made to the chart of account data. When an update occurs, such as the addition or modification of category attributes, the changes are propagated either through a direct push to the local storage on the user device 702 or by updating the remote table in the server system 704. If the table is stored remotely, the user device 702 retrieves the updated table upon the next data synchronization event, ensuring that the user always works with the most current set of valid category combinations.

Such real-time updating is possible through the use of web technologies like AJAX or RESTful APIs, which facilitate dynamic data exchange between the server system 704 and the user device 702. This ensures that the interface remains responsive and accurate, providing users with up-to-date filtering options and preventing the selection of invalid category combinations.

As the skilled person will understand, examples of the invention can also be implemented in alternative fashions without departing from the core principles described. In certain embodiments, the graphical user interface module 401, the operation implementing module 402, and the data record database 407 may all be implemented locally on a single computing device, thereby eliminating any requirement for network-based communication. In such a scenario, the interface is displayed and controlled entirely by local software components, and the data records are maintained in local storage.

In other embodiments, the graphical user interface module 401 and the operation implementing module 402 may both be implemented locally, while the data record database 407 is hosted remotely, for example on a separate server or in a cloud-based environment. In this arrangement, the operation implementing module 402 retrieves and updates remotely stored data records via a suitable data connection, thereby enabling local control of the interface while leveraging off-site data storage.

In addition to these deployment variants, the graphical user interface module 401 and the operation implementing module 402 may be realised using any suitable software architecture or technology stack. For instance, the graphical user interface module 401 could be implemented as a web-based client (e.g. using HTML, CSS, Javascript, or a front-end framework), a native desktop application (e.g. written in C++, Java, or Python), or even a mobile application. The operation implementing module 402 might similarly be built as a standalone service or microservice, exposing a programmatic interface (e.g. an API) for interacting with the data record database 407 and other system components.

In the embodiments described above, the selection control is provided by a drop-down menu for each category. The user picks from a list of possible category attributes, and any attributes deemed invalid (based on earlier selections) are “greyed out” so that the user cannot select them. As the skilled person will appreciate, any suitable interface elements can be employed for this purpose. For example, radio buttons, check boxes, auto-complete text fields, or tiles could be provided to allow selection of category attributes. Similarly, invalid choices can be excluded or indicated in other ways, such as by hiding them entirely, highlighting them in a different colour, or displaying a notification when the user attempts to select them.

Examples of the invention have been described in terms of accounting systems, where data records are allocated to combinations of account categories and dimension category attributes (sometimes referred to as “plan lines”). However, the skilled person will appreciate that the inventive concepts disclosed herein can have utility in many other fields in which data records are allocated to combinations of interrelated categories. For instance, in an inventory management context, items may be classified by category, size, or supplier, and only certain combinations may be relevant; in an e-commerce setting, products might be grouped by brand, model, or region, rendering some category combinations invalid; and in healthcare systems, patient records may be associated with specific wards and treatment types, where certain diagnoses are not supported in certain wards.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A computer implemented method of filtering a plurality of data records stored in a data record system and subsequently performing an operation on the filtered data records, wherein
said data records are stored in the data record system such that each data record is allocated to a combination of categories from a set of categories, and each category of the combination of categories has a category attribute selected from a set of category attributes associated with that category such that each data record is allocated to a particular combination of category attributes and wherein
only certain combinations of category attributes are valid reflecting a limited set of category attribute combinations to which a data record can be validly allocated, said method comprising:
a) providing, via a graphical user interface on a computing device, a plurality of selection controls corresponding to each category and via which the category attributes for each category can be selected;
b) sequentially receiving one or more selection data inputs from a user via the selection controls, each selection data input indicative of a category attribute of a category, and
c) every time a selection data input is received, identify, for each of the categories of the combination of categories to which the data record is allocated, category attributes which if subsequently selected would form a non-valid set of category attributes given the category attributes selected in accordance with the previously received selection data inputs, and exclude the identified category attributes from selection via the selection controls,
d) receiving confirmation data input indicating a full set of selection data inputs has been provided and receiving operation instruction data indicative of an operation, and
e) performing the operation on the subset of data records stored in the data record system that are assigned a combination of category attributes that include the category attributes indicated by the received selection data inputs.

2. A method according to claim 1, wherein the data records are budget allocation data records.

3. A method according to claim 2, wherein the set of categories comprises an account code category corresponding to account codes, and the remaining categories comprise account dimensions categories, each account dimension category representing a class of attributes associated with budget allocations.

4. A method according to claim 3, wherein the set of category attributes associated with the account code category comprise a set of account codes.

5. A method according to claim 4, wherein the set of category attributes associated with each account dimension category comprise a set of budget allocation attributes associated with that account dimension category.

6. A method according to claim 1, wherein step c) comprises identifying the category attributes by referencing a data set indicative of valid category attribute sets.

7. A method according to claim 1, wherein step c) comprises excluding selection of one or more attributes by one of: (i) greying out or disabling said attributes within a selection control; (ii) removing or hiding said attributes from the selection control; (iii) displaying a warning or error message when a user attempts to select said attributes; or (iv) highlighting said attributes as invalid using a distinguishing colour or icon.

8. A method according to claim 1, wherein the plurality of selection controls comprise a plurality of drop-down menus.

9. A method according to claim 8, wherein the plurality of drop-down menus comprise a drop-down menu for each category, and wherein a graphical element corresponding to each category attribute is presented via the respective drop-down menu, and selection data input is received indicative of selection of a category attribute on selection of a graphical element corresponding to that graphical element.

10. A method according to claim 1, wherein the operation is one of a predetermined set of operations, and comprises a display operation in which the subset of data records are displayed on the graphical user interface.

11. A method according to claim 1, wherein the operation is one of a predetermined set of operations, and comprises a data processing operation in which a data processing operation is applied to the subset of data records.

12. A method according to claim 1, wherein the graphical user interface is provided within a computer implemented tool for undertaking accounting budgeting tasks.

13. A computer system for enabling a user to filter a plurality of data records stored in a data record system and subsequently performing an operation on the filtered data records, wherein
said data records are stored in the data record system such that each data record is allocated to a combination of categories from a set of categories, and each category of the combination of categories has a category attribute selected from a set of category attributes associated with that category such that each data record is allocated to a particular combination of category attributes and wherein
only certain combinations of category attributes are valid reflecting a limited set of category attribute combinations to which a data record can be validly allocated, said system comprising:
a display connected to a computing device wherein a display function is configured to control the computing device to display, on the display, a graphical user interface comprising a plurality of selection controls corresponding to each category and via which the category attributes for each category can be selected;
a user input connected to the computing device, wherein an input data processing function is configured to sequentially receive one or more selection data inputs via the selection controls from the user input, each selection data input indicative of a category attribute of a category;
the display connected to a computing device, wherein a filter function which each time a selection data input is received, is configured to identify, for each of the categories of the combination of categories to which the data record is allocated, category attributes which if subsequently selected would form a non-valid set of category attributes given the category attributes selected in accordance with the previously received selection data inputs, and control the display function to exclude the identified category attributes from selection via the selection controls, and
an operation implementing module which upon the input data processing receiving function receiving confirmation data input indicating a full set of selection data inputs has been provided and receiving operation instruction data indicative of an operation, is configured to perform the operation on the subset of data records stored in the data record system that are assigned a combination of category attributes that include the category attributes indicated by the received selection data inputs.

14. A system according to claim 13, wherein the data records are budget allocation data records.

15. A system according to claim 14, wherein the set of categories comprises an account code category corresponding to account codes, and the remaining categories comprise account dimensions categories, each account dimension category representing a class of attributes associated with budget allocations.

16. A system according to claim 15, wherein the set of category attributes associated with the account code category comprise a set of account codes.

17. A system according to claim 16, wherein the set of category attributes associated with each account dimension category comprise a set of budget allocation attributes associated with that account dimension category.

18. A system according to claim 17, wherein the filter function is configured to identify the category attributes by referencing a data set indicative of valid category attribute sets.

19. A system according to claim 18, wherein the display function is configured to exclude selection of one or more attributes by control the computing device to display on the display connected the graphical user interface such that one of: (i) said attributes are greyed out or disabled within a selection control; (ii) said attributes are removed or hidden from the selection control; (iii) a warning or error message is displayed when a user attempts to select said attributes;
or (iv) said attributes are highlighted as invalid using a distinguishing colour or icon.

20. A system according to claim 19, wherein the plurality of selection controls comprise a plurality of drop-down menus.

21. A system according to claim 20, wherein the plurality of drop-down menus comprise a drop-down menu for each category, and wherein a graphical element corresponding to each category attribute is presented via the respective drop-down menu, and selection data input is received indicative of selection of a category attribute on selection of a graphical element corresponding to that graphical element.

22. A system according to claim 21, wherein the operation is one of a predetermined set of operations, and comprises a display operation in which the subset of data records are displayed on the graphical user interface.

23. A system according to claim 22, wherein the operation is one of a predetermined set of operations, and comprises a data processing operation in which a data processing operation is applied to the subset of data records.

24. A system according to claim 23, wherein the graphical user interface is provided within a computer implemented tool for undertaking accounting budgeting tasks.

25. (canceled)
